(19) United States
(12) Patent Application Publication
(10) Pub. No.: US 2016/0023883 A1
(43) Pub. Date: Jan. 28, 2016

(54) Intermittent Dosing

(71) Applicant: PEPSICO, INC., Purchase, NY (US)

(72) Inventor: Steven Jersey, Laguna Niguel, CA (US)

(21) Appl. No.: 14/774,777

(22) PCT Filed: Mar. 14, 2014
(86) PCT No.: PCT/US14/28484

§ 371 Date: Sep. 11, 2015

Related U.S. Application Data
(60) Provisional application No. 61/782,615, filed on Mar. 14, 2013.

(51) Int. Cl. B67D 1/12; B67D 1/00

(52) U.S. Cl. CPC B67D 1/1204; B67D 1/0039; B67D 1/122

(57) ABSTRACT

A system comprising a highly concentrated micro component source, an accumulator, a micro component valve and a controller. The accumulator may be configured to keep the highly concentrated micro component under a first pressure. The micro component valve may be configured to dose the highly concentrated micro component at the first pressure for a first period of time. The controller may be configured to control the dosing of the highly concentrated micro component by the micro component valve. The system may further comprise a source of a diluent configured to provide a flow of the diluent during a second period of time at a second pressure. The highly concentrated micro component along with the diluent may be dosed using different time periods and under different pressures.

### CROSS REFERENCE TO RELATED APPLICATIONS

This application claims priority to U.S. Provisional Application No. 61/782,615, filed on Mar. 14, 2013, entitled “Intermittent Dosing,” and is related to U.S. Provisional Application No. 61/695,135, filed on Aug. 30, 2012, entitled “Intermittent Dosing of Liquids,” and International Application No. PCT/US 13/57015, filed on Aug. 28, 2013, entitled “Intermittent Dosing of Liquids,” the entire disclosures of which are hereby incorporated by reference in their entirety and for all purposes.

### FIELD OF THE INVENTION

This disclosure relates generally to a method and beverage dispensing system for the dispensing of beverages, e.g., for cafeterias, restaurants (including fast food restaurants), theatres, convenience stores, gas stations, and other entertainment and/or food service venues.

### BACKGROUND

Various beverage dispensers, such as those at cafeterias, restaurants, theatres and other entertainment and/or food service venues, typically have either a “drop in” dispenser apparatus or a counter top type dispenser apparatus. In a drop in dispenser apparatus, the dispenser apparatus is self-contained and may be dropped into an aperture of a counter top. In a counter top type dispenser apparatus, the dispenser apparatus is placed on a counter top. In conventional beverage dispensers, a dispensing head is coupled to a particular drink syrup supply source via a single pipe dedicated to supply the particular drink syrup to that dispensing head, wherein the particular drink syrup supply source is typically located near the counter top, i.e., directly under the counter top, or directly over the counter top.

A user will typically place a cup under the signage of the selected beverage and either press a button or press the cup against a dispensing lever to activate the dispenser so that the selected beverage is delivered from the dispensing head corresponding to the selected beverage and into the cup until pressure is withdrawn from the button or lever.

Conventional beverage dispensers are typically limited to dispensing a limited number of drinks. For example, drinks typically available at a conventional beverage dispenser are a regular cola beverage, a diet cola beverage, perhaps one or several non-cola carbonated beverages, such as a lemon-lime flavored carbonated beverage or some other fruit-flavored drink (e.g., orange flavored carbonated beverage, and/or root beer), and perhaps one more non-carbonated beverage(s), such as a tea and/or a lemonade.

Conventional dispensers typically dose simultaneously components of a mixture or beverage, and the final product is obtained as a result of mixing of two or more continuous flows of the product components. This conventional approach may work well when only low concentrated components are used. If, however, one or more of the components is highly concentrated, the flow rate of such highly concentrated component(s) required for continuous mixing becomes very small. In order to create and maintain such very small and stable flows, very precise and thus more expensive dosing and dispensing equipment is required. Less expensive but less precise equipment may be able to dose highly concentrated components with required level of accuracy, but the resulting flow rate of the created flow of such components may be unacceptably high and thus inappropriate for continuous mixing of flows.

What is needed is a beverage dispensing system that does not have the limitations and disadvantages of conventional beverage dispensers and methods.

### SUMMARY

In one aspect of the disclosure, there is provided an intermittent dosing system. The intermittent dosing system is configured to dose and dispense at least one highly concentrated free-flowing micro component. In an aspect of the disclosure, the intermittent dosing system is configured to dose and intermittently dispense at least one highly concentrated free-flowing micro component.

In one aspect of the disclosure a system is provided, the system comprising a source of a diluent configured to provide a flow of the diluent and a source of a highly concentrated micro component to be received in a micro dosing device. The highly concentrated micro component along with the diluent may be dosed using different time periods and under different pressures. The micro dosing device is configured to receive and dose the highly concentrated micro component or micro components under different pressures and at different time intervals than the diluent.

In another aspect of the disclosure, the system comprising a source of a diluent is configured to provide a flow of the diluent during a first period of time, a source of a highly concentrated micro component, and a micro dosing device. The micro dosing device is configured to receive the highly concentrated micro component from the source of the highly concentrated micro component and dose the highly concentrated micro component during a second period of time. The second period of time may be less than the first period of time, and the second period of time may overlap with a portion of the first period of time. The system comprises a controller, the controller configured to control the dosing of the highly concentrated micro component by the micro dosing device. The system comprises a dispenser, the dispenser configured to allow mixing in the dispenser of the highly concentrated micro component dosed by the micro dosing device and the flow of the diluent.

The above and other aspects, features and advantages of the present disclosure will be apparent from the following detailed description of the illustrated embodiments thereof which are to be read in connection with the accompanying drawings.

### BRIEF DESCRIPTION OF THE DRAWINGS

FIG. 1 is schematic view of an embodiment of a dispensing system according to various aspects of the disclosure.

FIG. 1A illustrates another schematic view of a dispensing system in accordance with various aspects of the disclosure.

FIG. 2 illustrates a time diagram of dispensing in accordance with various aspects of the disclosure.

FIG. 3 illustrates a time diagram of dispensing in accordance with various aspects of the disclosure.

FIG. 4 illustrates a time diagram of dispensing in accordance with various aspects of the disclosure.

FIG. 5 illustrates a flow diagram of a method in accordance with various aspects of the disclosure.

FIG. 6 illustrates a dosing control unit in accordance with various aspects of the disclosure.

### DETAILED DESCRIPTION OF THE PREFERRED EMBODIMENTS

The embodiments discussed below may be used to form a wide variety of beverages, including but not limited to cold and hot beverages, and including but not limited to beverages known under any PepsiCo branded name, such as Pepsi-Cola®.

Those of ordinary skill in the art will recognize that a transfer unit or dosing system and/or portions thereof that feed a dispenser with a free flowing product may be located remotely from a counter, such as in a back room, or at the counter, such as below or over the counter.

In one aspect of the disclosure, a method is provided, the method comprising providing a flow of the diluent during a first period of time and dosing a highly concentrated micro component during a second period of time, the second period of time being less than the first period of time, the second period of time overlapping with a portion of the first period of time. The method may further comprise controlling the dosing of the highly concentrated micro components at different pressures for varying amounts of time.

In one aspect of the disclosure a system is provided, the system comprising a source of a diluent configured to provide a flow of the diluent during a first period of time, and a plurality of highly concentrated micro component sources, each of the plurality of highly concentrated micro component sources having a corresponding micro component. The system may comprise a plurality of micro dosing devices, each micro dosing device configured to receive a highly concentrated micro component from a corresponding source of highly concentrated micro component, each micro dosing device configured to provide dosing of the highly concentrated micro component corresponding thereto during a second period of time. The second period of time may be less than the first period of time, the second period of time overlapping with a portion of the first period of time. The system may comprise a controller, the controller configured to control the dosing of the highly concentrated micro component by each micro dosing device. The system may comprise a dispenser, the dispenser configured to allow mixing in the dispenser of the highly concentrated micro components dosed by the micro dosing devices and the flow of the diluent.

In an aspect of the disclosure, an apparatus is provided, the apparatus comprising a cartridge comprising a highly concentrated free flowing micro component having a ratio by weight of the highly concentrated free-flowing micro component to a diluent of at least about 30:1. In an aspect, the ratio by weight of the highly concentrated free-flowing micro component to a diluent of at least about 1000:1. The apparatus may comprise a dosing device, the dosing device configured to intermittently dose a predetermined amount of the highly concentrated free-flowing micro component at a predetermined flow rate. The apparatus may comprise a controller, the controller configured to control the intermittent dosing by the dosing device.

In an aspect of the disclosure, an apparatus is provided, the apparatus comprising a cartridge comprising a highly concentrated free flowing micro component for a food product. The apparatus may comprise a dosing device, the dosing device configured to intermittently dose a predetermined amount of the highly concentrated free-flowing micro component at a predetermined flow rate. The apparatus may comprise a source of a free-flowing macro component for the food product. The apparatus may comprise a mixing device, the mixing device configured to receive the highly concentrated free-flowing micro component dosed by the dosing device and the free-flowing macro component from the source of the free-flowing macro component. The apparatus may comprise a controller, the controller configured to control the intermittent dosing by the dosing device so that the dosing device doses the highly concentrated free-flowing component to the mixing device for a period of time that is less than the period of time in which the free-flowing macro component is dispensed to the mixing device.

In an aspect of the disclosure, a method is provided. The method may comprise intermittent dispensing of a predetermined amount of a highly concentrated free-flowing micro component for a food product, dispensing a predetermined amount of a free-flowing macro component for the food product, combining the highly concentrated free-flowing micro component and the free-flowing macro component, the intermittent dispensing of the free-flowing micro component being less than the period of time in which the free-flowing macro component is dispensed.

In one aspect of the disclosure, there is provided an intermittent dosing system. The intermittent dosing system is configured to dose and dispense at least one highly concentrated free-flowing micro component. In an aspect of the disclosure, the intermittent dosing system is configured to dose and intermittently dispense at least one highly concentrated free-flowing micro component. By way of example, but not limitation, the intermittent dosing system is configured to dose and intermittently dispense a highly concentrated free-flowing micro component wherein the ratio by weight of the highly concentrated free-flowing micro component to a diluent (e.g., water) may be the following: high fructose corn syrup (HFCS)—at least 5:1; non-nutritive sweetener—at least about 19:1 e.g., between 15:1 and 45:1; lemonade flavoring—at least 100:1; non-cola carbonated soft drink—at least 150:1; carbonated cola soft drink—at least 500:1. For a relatively pure concentrate, the ratio by weight of a highly concentrated free-flowing micro component to a diluent (e.g., water) is at least 200:1.

In an aspect of the disclosure, an apparatus is provided, the apparatus comprising a cartridge comprising a highly concentrated free flowing micro component having a ratio by weight of the highly concentrated free-flowing micro component to a diluent of at least about 19:1. The apparatus may comprise a micro dosing device, the micro dosing device configured to intermittently dose a predetermined amount of the highly concentrated free-flowing micro component at a predetermined flow rate. The apparatus may comprise a controller, the controller configured to control the intermittent dosing by the micro dosing device.

In an aspect of the disclosure, an apparatus is provided, the apparatus comprising a cartridge comprising a highly concentrated free flowing micro component for a food product. The apparatus may comprise a dosing device, the dosing device configured to intermittently dose a predetermined amount of the highly concentrated free-flowing micro component at a predetermined flow rate. The apparatus may comprise a source of a free-flowing macro component for the food product. The apparatus may comprise a mixing device, the mixing device configured to receive the highly concentrated free-flowing micro component dosed by the micro dosing device and the free-flowing macro component from the source of the free-flowing macro component. The apparatus may comprise a controller, the controller configured to control the intermittent dosing by the micro dosing device so that the micro dosing device doses the highly concentrated free-flowing component to the mixing device for a period of time that is less than the period of time in which the free-flowing macro component is dispensed to the mixing device.

In an aspect of the disclosure, a method is provided. The method may comprise intermittent dispensing of a predetermined amount of a highly concentrated free-flowing micro component for a food product, dispensing a predetermined amount of a free-flowing macro component for the food product, combining the highly concentrated free-flowing micro component and the free-flowing macro component, the intermittent dispensing of the free-flowing micro component being less than the period of time in which the free-flowing macro component is dispensed.

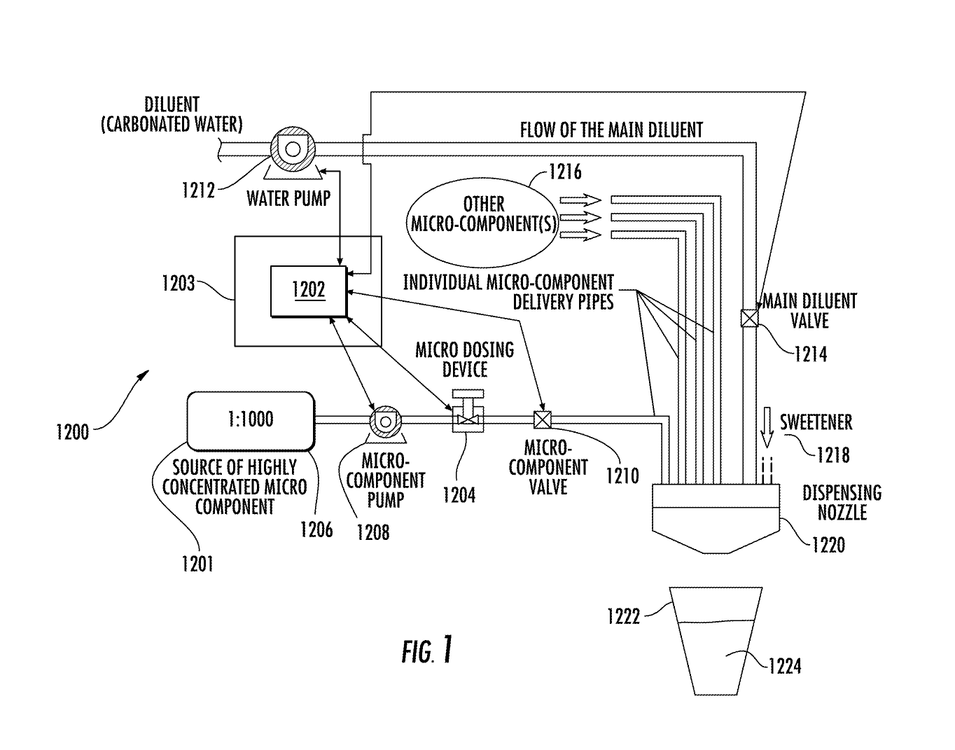

FIG. 1 shows a system 1200 comprising a dosing control unit 1203. Dosing control unit 1203 may comprise a controller 1202. Controller 1202 may be operatively connected to a dosing device 1204. In accordance with an aspect of the disclosure, controller 1202 may be configured to control dosing by dosing device 1204 so that the dosing is intermittent dosing of a highly concentrated micro component 1206. As shown in FIG. 1, two-way communication may be provided between controller 1202 and dosing device 1204 so that controller 1202 can deliver instructions to dosing device 1204, and dosing device 1204 can deliver to the controller 1202 information relating to the operation of dosing device 1204. Dosing device 1204 may be a dosing device configured to dose one or more liquid components of a plurality of sources. Each source may comprise a cartridge 1201. Each source may comprise a component of a free flowing product. The free flowing product may comprise a food product. The food product may comprise a beverage. Thus, each source of the plurality of sources may comprise a highly concentrated micro component. Each highly concentrated micro component may comprise, for example, one or more of beverage ingredients.

As shown in FIG. 1, controller 1202 may be configured to control operation of micro component pump 1208 and micro component valve 1210 via two way communication between controller 1202 and micro component pump 1208 and micro component valve 1210, respectively.

Controller 1202 may be configured to control intermittent dosing of one or more other micro components 1216, in a similar manner as for micro component 1206, e.g., controlling via two way communication (not shown) between controller 1202 and a micro dosing device, a micro component pump, and/or a micro component valve corresponding to each micro component 1216.

Controller 1202 may be configured to control dosing of a sweetener 1218, in a similar manner as for micro component 1206, e.g., controlling via two way communication (not shown) between controller 1202 and a dosing device, a pump, and/or a component valve corresponding to the sweetener 1218. In accordance with the present disclosure, dosing of the sweetener may be intermittent or not intermittent. In accordance with the present disclosure, a dosing device, a pump, and/or a component valve corresponding to the sweetener 1218 may be a micro dosing device, a micro component pump, and/or a micro component valve corresponding to sweetener 1218, respectively.

Controller 1202 may be configured to control operation of water pump 1212 and main diluent valve 1214 via two way communication between controller 1202 and water pump 1212 and main diluent valve 1214, respectively.

In accordance with an aspect of the disclosure, a highly concentrated liquid micro component 1206 is intermittently dosed and dispensed, and the intermittent dose of micro component 1206 may be mixed with the flow of other components 1216, and or mixed with a low concentrated and/or macro component(s). By using intermittent dosing and dispensing of the highly concentrated liquid micro component 1206, less precise and thus less expensive equipment is required than if the highly concentrated liquid micro component 1206 was continuously dosed and dispensed so as to mix with a continuous flow of low concentrated liquid macro component(s). For example, highly concentrated liquid micro component 1206 may mix with a flow of low concentrated liquid macro components prior to or at dispensing nozzle 1220. In an aspect of the present disclosure, highly concentrated liquid micro component 1206 may mix with a flow of low concentrated liquid macro components in cup 1222 placed underneath dispensing nozzle 1220. The mixing of highly concentrated liquid micro component 1206 and other beverage components results in a finished beverage 1224.

FIG. 1A shows another system 1200A for a dispensing system in accordance with various aspect of the disclosure that may be used in place of or with various components shown in FIG. 1. The control unit 1203 (of FIG. 1) may comprise a controller 1202 that may be operatively connected to a micro component valve 1204A. In accordance with an aspect of the disclosure, controller 1202 may be configured to control dosing by micro component valve 1204A so that the dosing is intermittent dosing of a highly concentrated micro component 1206.

Two-way communication may be provided between controller 1202 and micro component valve 1204A so that controller 1202 can deliver instructions to micro component valve 1204A, and micro component valve 1204A can deliver to the controller 1202 information relating to the operation of micro component valve 1204A. Micro component valve 1204A may be configured to dose one or more liquid components of a plurality of sources. Each source may comprise a cartridge 1201. Each source may comprise a component of a free flowing product. The free flowing product may comprise a food product. The food product may comprise a beverage. Thus, each source of the plurality of sources may comprise a highly concentrated micro component. Each highly concentrated micro component may comprise, for example, one or more of beverage ingredients.

Controller 1202 may be configured to control operation of micro component pump 1208A via two way communication between controller 1202 and micro component pump 1208A. Controller 1202 may be configured to control intermittent dosing of one or more other micro components 1216, in a similar manner as for micro component 1206, e.g., controlling via two way communication (not shown) between controller 1202 and a micro dosing device, a micro component pump, and/or a micro component valve corresponding to each micro component 1216.

Controller 1202 may also be configured to control operation of air vent 1103, accumulator 1105, and regulator 1107. The controller may control set points of each device to ensure proper dosing of the highly concentrated micro components. In another embodiment, air vent 1103, accumulator 1105, and regulator 1107 may be factory set and adjusted at various maintenance cycles.

In an embodiment, controller 1202 may retrieve from memory instructions regarding the dosing characteristics for a particular micro component. The dosing characteristics may include a pressure setting and dispensing time for each micro component. Based on the received dosing characteristics, controller 1202 may control micro component pump 1208A and micro component value 1204A based on those characteristics. For instance, in an embodiment, micro component pump 1208A may pump highly concentrated micro component 1206 from its cartridge 1201 via check valve 1101. An air vent 1103 may remove any air trapped in the line between the micro component pump 1208A discharge through to the micro component valve 1204A.

In an aspect of the disclosure, accumulator 1105 may store or keep the highly concentrated micro component 1206 under a set pressure until instructed by the controller 1202 to open micro component valve 1204A. The pressure may be regulated by a regulator 1107 based upon the particular micro component characteristics and/or other external factors such as ambient temperature or pressure. In an embodiment, controller 1202 based on the dosing characteristics, including the pressure setting for each of micro components stored in the accumulator, opens the micro component value 1204A for a corresponding amount of time to dose a predetermined amount of micro component. For example, a particular micro component may have a pressure regular setting of approximately twenty-five psi and enable its associated micro component value to stay open for approximately eight milliseconds. In another embodiment, a micro component that that includes a more viscous product such as a juice may require a higher pressure and/or a longer micro component value opening time to obtain proper dosing.

Controller 1202 may be configured to control dosing of a sweetener 1218, in a similar manner as for micro component 1206, e.g., controlling via two way communication (not shown) between controller 1202 and a micro component valve, a pump, and/or a component valve corresponding to the sweetener 1218. In accordance with the present disclosure, dosing of the sweetener may be intermittent or not intermittent. In accordance with the present disclosure, the sweetener 1218 may be located under a counter or remotely such as in a back room. The sweetener 1218 may be connected via a connector to a dual acting diagram pump which extracts the sweetener and pumps it to the front room having the dispenser. An air vent may be located near the pump discharge to remove any trapped air. A regulator may be used to regulate the pressure of the sweetener stream. In an embodiment, the sweetener stream may be dosed by a micro component valve. In another embodiment, the sweetener stream may be split into multiple sweetener streams and dosed by multiple micro component valves to provide a more uniform flow pattern with improved final beverage characteristics.

In another aspect of the disclosure, controller 1202 may also be configured to control dosing of a non-nutritive sweetener. The non-nutritive sweetener may be dosed similar to the sweetener stream 1218, discussed above. The non-nutritive sweetener may also be split into multiple streams to provide a more uniform flow pattern with improved final beverage characteristics.

Controller 1202 may be configured to control operation of water pump 1212 and main diluent valve 1214 via two way communication between controller 1202 and water pump 1212 and main diluent valve 1214, respectively. In an embodiment, two independent diluent streams may be utilized such as a carbonated diluent stream and a non-carbonated diluent stream. Each diluent stream may have its own dilute pump 1212A and 1212B. In an embodiment, the diluent streams may be treated in the back room with a water treatment package to remove all of the chlorine. Also, the total alkalinity may also be reduced. The diluent streams may be pumped to the front room having the dispenser through a recirculating system. In an embodiment, both the carbonated diluent stream and the non-carbonated diluent stream are recirculated. The recirculated diluent streams provide increased beverage selections as beverages having different compositions of carbonated and non-carbonated diluents may be dosed.

In an alternative embodiment, the dispensing system may include a low volumetric dosing device. A low volumetric dispensing system may include a pump, an accumulator, an air vent, and the low volumetric dosing device. The low volumetric dosing device may include a fillable chamber to hold and dispense precise amounts of the micro component based on the beverage selection.

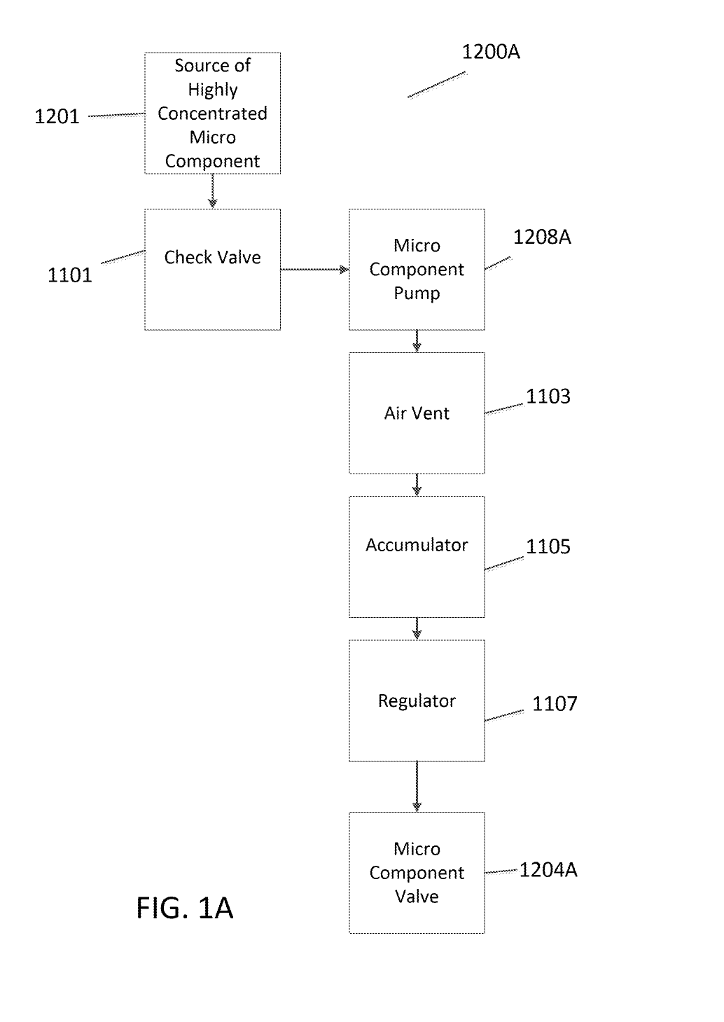

FIG. 2 illustrates dispensing of a portion of beverage in accordance with an embodiment of the present disclosure. As shown in FIG. 2, a highly concentrated micro component(s) 1308 is intermittently dispensed from time 1310 to time 1312, from time 1314 to time 1316, from time 1318 to time 1320, from time 1322 to time 1324, from time 1326 to time 1328, and from time 1330 to time 1332. As shown in FIG. 2, a macro component 1304 is continuously dispensed from time 1302 to time 1306. As shown in FIG. 2, in an aspect of the disclosure, time 1302 may be the same as time 1310.

The length and frequency of the intermittent dosing times of highly concentrated micro component 1308 may be selected so that the total amount of micro component 1308 will meet the desirable composition of the dispensed mixture, e.g., the dispensed mixture 1220.

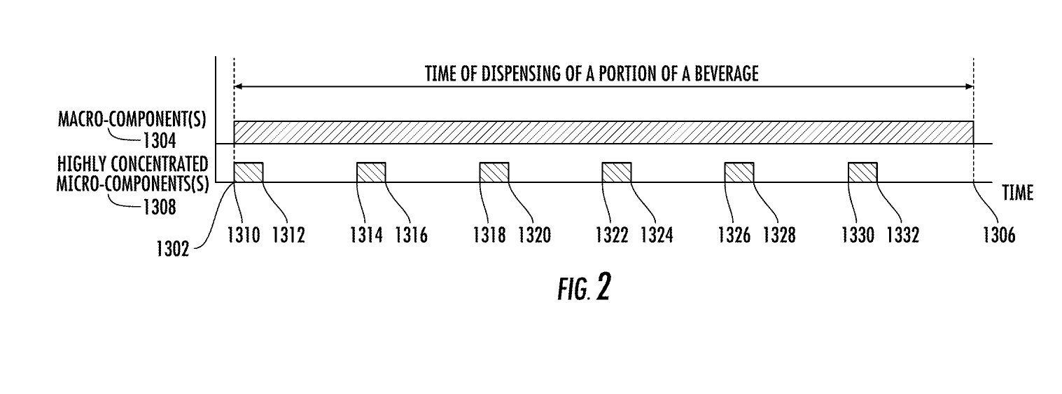

FIG. 3 illustrates an optional approach, wherein dispensing of a highly concentrated micro component 1400 is dispensed from time 1410 to time 1412. FIG. 3 illustrates dispensing of a macro component 1404 from time 1402 to time 1406. Macro component dispensing time 1402 to time 1406 may be longer than micro component dispensing time 1410 to time 1412. Time 1402 may be the same as time 1410. The start of micro component dispensing time 1410 and the start of macro component dispensing time 1402 may begin when a customer or user activates dispensing, such as by e.g., activating an actuator, e.g., pressing a start button or otherwise activates the dispensing.

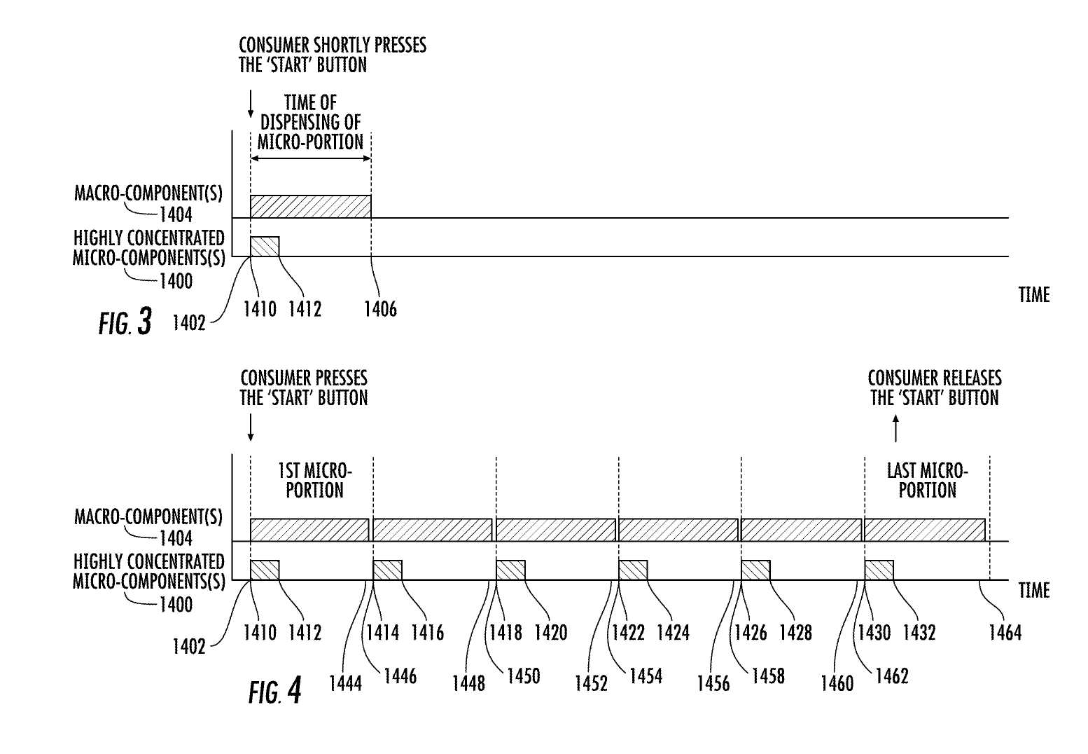

FIG. 4 illustrates dispensing of a highly concentrated micro component 1400 is performed sequentially from time 1410 to time 1412, from time 1414 to time 1416, from time 1418 to time 1420, from time 1422 to time 1424, from time 1426 to time 1428, and from time 1430 to time 1432.

As shown in FIG. 4, macro component 1404 may be dispensed sequentially from time 1402 to time 1444, from time 1446 to time 1448, from time 1450 to time 1452, from time 1454 to time 1456, from time 1458 to time 1460, and from time 1462 to time 1464.

As shown in FIG. 4, in an aspect of the disclosure, time 1402 may be the same as time 1410, time 1446 may be the same as time 1414, time 1450 may be the same as time 1418, time 1454 may be the same as time 1422, time 1458 may be the same as time 1426, and time 1462 may be the same as time 1430.

As shown in FIG. 4, in an aspect of the disclosure, time 1444 is prior to time 1446 and time 1414, time 1448 is prior to time 1450 and 1418, time 1452 is prior to time 1454 and 1422, time 1456 is prior to time 1458 and 1426, and time 1460 is prior to time 1462 and time 1430.

As illustrated in FIG. 4, macro component dispensing time 1402 to time 1444 may be longer than micro component dispensing time 1410 to time 1412, macro component dispensing time 1446 to time 1448 may be longer than micro component dispensing time 1414 to time 1416, macro component dispensing time 1450 to time 1452 may be longer than micro component dispensing time 1418 to time 1420, macro component dispensing time 1454 to time 1456 may be longer than micro component dispensing time 1422 to time 1424, macro component dispensing time 1458 to time 1460 may be longer than micro component dispensing time 1426 to time 1428, and macro component dispensing time 1462 to time 1464 may be longer than micro component dispensing time 1430 to time 1432.

The start of micro component dispensing time 1402 and the start of macro component dispensing time 1406 may begin when a customer or user presses a start button or otherwise activates the dispensing.

The start of micro component dispensing time 1402 and the start of macro component dispensing time 1406 may begin when a customer or user presses a start button or otherwise activates the dispensing. The end of micro component dispensing time 1416 may occur when a customer or user releases a start button or otherwise activates the end of dispensing of the micro component. As shown in FIG. 4, since macro component dispensing time 1426 may be longer than micro component dispensing time 1416, macro component dispensing time 1426 may not end at the same time as micro component dispensing time 1416 ends.

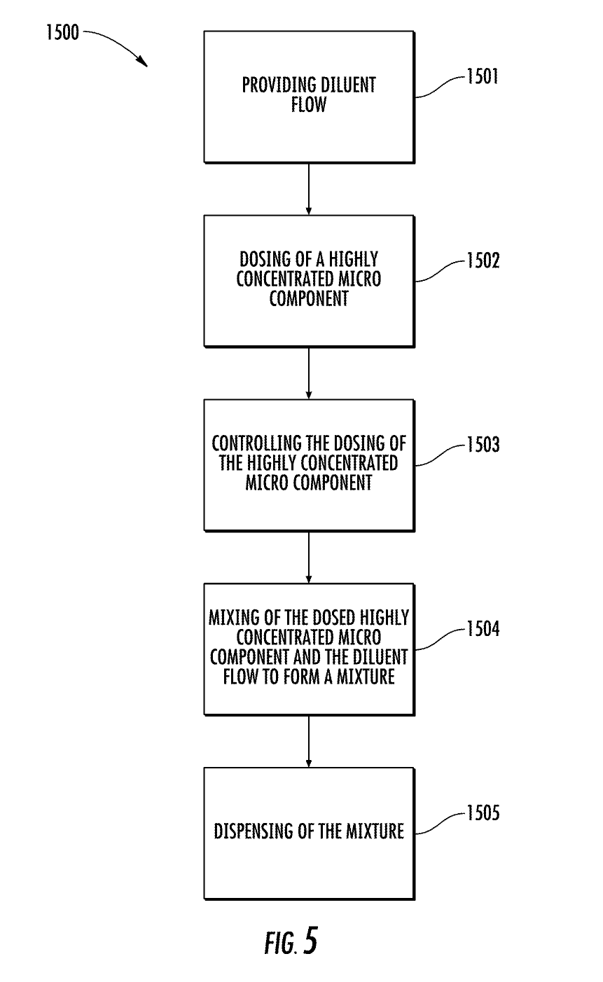

FIG. 5 illustrates a flow diagram of a method 1500 in accordance with various aspects of the disclosure. In step 1501, a flow of a diluent is provided during a first period of time. In step 1502, dosing of a highly concentrated micro component occurs during a second period of time. The second period of time may be less than the first period of time. The second period of time may overlap with a portion of the first period of time. In step 1503, controlling the dosing of the highly concentrated micro component occurs. In step 1504, mixing of the dosed highly concentrated micro component and the flow of the diluent to form a mixture occurs. In step 1505, dispensing of the mixture from a dispenser occurs.

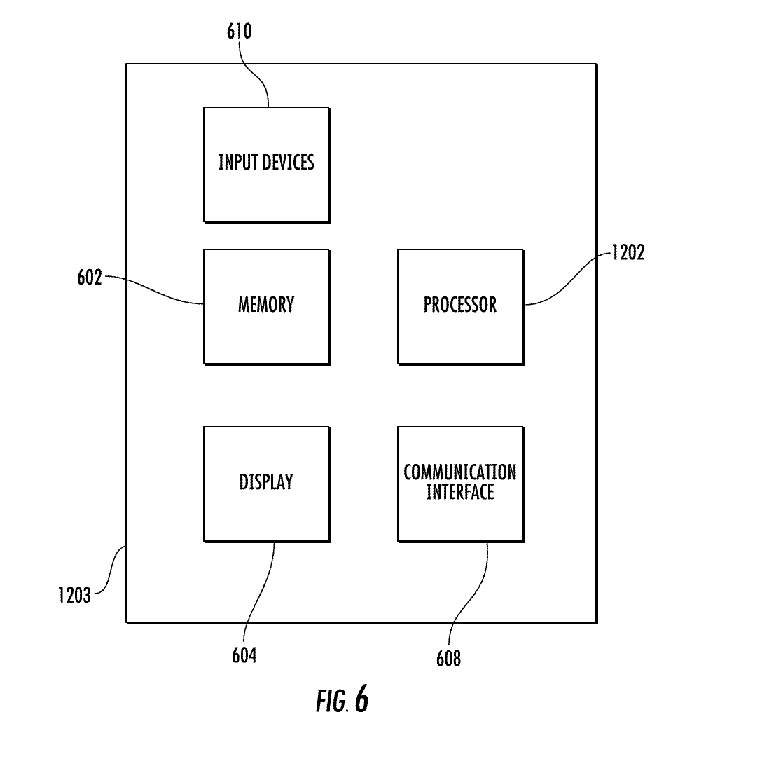

FIG. 6 illustrates an example of a dosing control unit 1203, as shown in FIG. 1.

Dosing control unit 1203 may comprise a controller 1202 as shown in FIG. 1. Controller 1202 may comprise a processor. Dosing control unit 1203 may further comprise at least one non-transitory memory 602, a display 604, and a communication interface 608. Controller 1202 may execute computer-executable instructions present in non-transitory memory 602 such that, for example, dosing control unit 1203 may send and receive information via a network (not shown).

Dosing control unit 1203 may further include or be in communication with a system bus (not shown). A system bus may be any of several types of bus structures including a memory bus or memory controller, a peripheral bus, and a local bus using any of a variety of bus architectures. The structure of system non-transitory memory is well known to those skilled in the art and may include a basic input/output system (BIOS) stored in a read only memory (ROM) and one or more program modules such as operating systems, application programs and program data stored in random access memory (RAM). Dosing control unit 1203 may be configured to allow dosing control unit 1203 to communicate other devices in system 1200, for example, micro-component pump 1208, micro dosing device 1204, micro-component valve 1210, water pump 1212, and/or main diluent valve 1214. Dosing control unit 1203 may also include a variety of interface units and drives (not shown) for reading and writing data.

Those of skill in the art will recognize that, in accordance with the disclosure, any suitable network connections and other ways of establishing a communications link between dosing control unit 1203 and other devices in system 1200. The existence of any of various well-known protocols, such as TCP/IP, Frame Relay, Ethernet, FTP, HTTP and the like, is presumed, and a central processor unit or computer may be operated in a client-server configuration to permit a user to retrieve web pages from a web-based server. Furthermore, any of various conventional web browsers may be used to display and manipulate data on web pages.

Those of skill in the art will recognize that, in accordance with the disclosure, dosing control unit 1203 may include an associated computer-readable medium containing instructions for controlling system 1200 and implement the exemplary embodiments that are disclosed herein.

Dosing control unit 1203 may also include various input devices 610. Input devices 610 may include keyboards, track balls, readers, mice, joy sticks, buttons, and bill and coin validators.

In accordance with aspects of the disclosure, a system is provided comprising a source of a diluent configured to provide a flow of the diluent during a first period of time. The system may comprise a source of a highly concentrated micro component. The system may comprise a micro dosing device, wherein the micro dosing device may be configured to receive the highly concentrated micro component from the source of the highly concentrated micro component and dose the highly concentrated micro component during a second period of time. The second period of time may be less than the first period of time, and the second period of time may overlap with a portion of the first period of time. The system may comprise a controller. The controller may be configured to control the dosing of the highly concentrated micro component by the micro dosing device. The system may comprise a dispenser. The dispenser may be configured to allow mixing in the dispenser of the highly concentrated micro component dosed by the micro dosing device and the flow of the diluent.

In accordance with various aspects of the disclosure, the dispenser may comprise a dispensing nozzle. The dispensing nozzle may be configured to dispense a mixture of the highly concentrated micro component dosed by the micro dosing device and the flow of the diluent in the dispenser.

In accordance with various aspects of the disclosure, the system may comprise a micro component pump. The micro component pump may be positioned upstream of the micro dosing device. The micro component pump may be positioned downstream of the source of the highly concentrated micro component. The controller may be configured to control the operation of the micro component pump.

In accordance with various aspects of the disclosure, the system may comprise a micro component valve. The micro component valve may be positioned downstream of the micro dosing device and upstream of the dispenser. The controller may be configured to control the operation of the micro component valve. For example, the controller may be configured to control the operation of equipment so that the second period of time may begin at about the same time as the first period of time begins.

In accordance with various aspects of the disclosure, the system may comprise the source of a highly concentrated micro component that has a ratio by weight of micro component to a diluent of at least 1000:1. The diluent may comprise a macro component. The diluent may comprise water.

In accordance with various aspects of the disclosure, the system may comprise a main diluent valve. The main diluent valve may be configured to provide the diluent from the source of diluent to the dispenser. The controller may be configured to control the operation of the main diluent valve.

In accordance with various aspects of the disclosure, the system may comprise a micro dosing device configured to receive the highly concentrated micro component from the source of the highly concentrated micro component, and may provide dosing of the highly concentrated micro component during a third period of time. The third period of time may be less than the first period of time. The third period of time may overlap with a portion of the first period of time. In an aspect, the third period of time does not overlap with the second period of time, and the second period of time and third period of time in combination are less than the first period of time. The second period of time and the third period of time may be of substantially equal duration. The second period of time may begin at about the same time that the first period of time begins. The third period of time may end before the first period of time ends.

In accordance with various aspects of the disclosure, the system may comprise an actuator. The actuator may be configured to be actuated by a user. In an aspect, when a user actuates the actuator, the micro dosing device doses the highly concentrated micro component for the second period of time.

In accordance with various aspects of the disclosure, a method of dosing is provided. The method may comprise providing a flow of the diluent during a first period of time. The method may comprise dosing a highly concentrated micro component during a second period of time. The second period of time may be less than the first period of time. The second period of time may overlap with a portion of the first period of time. The method may comprise controlling the dosing of the highly concentrated micro component. The method may comprise mixing of the dosed highly concentrated micro component and the flow of the diluent to form a mixture. The method may comprise dispensing the mixture from the dispenser.

In accordance with various aspects of the disclosure, the method may further comprise dosing of the highly concentrated micro component during a third period of time, the third period of time being less than the first period of time. The third period of time may overlap with a portion of the first period of time. The second period of time may end before the third period of time begins, and the second period of time and third period of time in combination may be less than the first period of time. The second period of time and the third period of time may be of substantially equal duration. The second period of time may begin at about the same time that the first period of time begins. The third period of time may end before the first period of time ends. The method may further comprise actuating an actuator, the actuator configured to be actuated by a user, wherein when a user actuates the actuator, the dosing begins of the highly concentrated micro component for the second period of time. In an aspect, when the user stops actuating the actuator, the dosing of the highly concentrated micro component ends.

In accordance with various aspects of the disclosure, the system may comprise a source of a diluent configured to provide a flow of the diluent during a first period of time. The system may comprise a plurality of highly concentrated micro component sources, each of the plurality of highly concentrated micro component sources having a corresponding micro component. The system may comprise a plurality of micro dosing devices, each micro dosing device configured to receive a highly concentrated micro component from a corresponding source of highly concentrated micro component. Each micro dosing device may be configured to provide dosing of the highly concentrated micro component corresponding thereto. The system may comprise a controller. The controller may be configured to control the dosing of the highly concentrated micro component by each micro dosing device corresponding thereto such that at least one highly concentrated micro component is dosed during a second period of time, the second period of time being less than the first period of time, the second period of time overlapping with a portion of the first period of time. The system may comprise a dispenser. The dispenser may be configured to allow mixing in the dispenser of the highly concentrated micro components dosed by the micro dosing devices and the flow of the diluent. The system may comprise a dispensing nozzle configured to dispense a mixture of the highly concentrated micro components dosed by the micro dosing devices and the flow of the at least one diluent in the dispenser.

Those of skill in the art will recognize that in accordance with the disclosure any of the features and/or options in one embodiment or example can be combined with any of the features and/or options of another embodiment or example.

The disclosure herein has been described and illustrated with reference to the embodiments of the figures, but it should be understood that the features of the disclosure are susceptible to modification, alteration, changes or substitution without departing significantly from the spirit of the disclosure. For example, the dimensions, number, size and shape of the various components may be altered to fit specific applications. Accordingly, the specific embodiments illustrated and described herein are for illustrative purposes only.

We claim:

1. A system comprising:
a source of a highly concentrated micro component;
an accumulator configured to keep the highly concentrated micro component under a first pressure;
a micro component valve configured to dose one or more liquid components of a plurality of sources at the first pressure for a first period of time, the one or more liquid components of a plurality of sources comprising the highly concentrated micro component; and
a controller, the controller configured to control the dosing of the highly concentrated micro component by the micro component valve.

2. The system of claim 1 wherein the controller is configured to control the operation of the accumulator.

3. The system of claim 1 further comprising a micro component pump positioned downstream of the source of the highly concentrated micro component and upstream of the micro component valve.

4. The system of claim 3 wherein the controller is configured to control the operation of the micro component pump.

5. The system of claim 4 further comprising a check valve, the micro component pump configured to pump the highly concentrated micro component from the source of the highly concentrated micro component through the check valve.

6. The system of claim 1 further comprising a source of a diluent configured to provide a flow of the diluent during a second period of time at a second pressure, wherein the second period of time begins at the same time as the first period of time begins.

7. The system of claim 1 further comprising a source of a diluent configured to provide a flow of the diluent during a second period of time at a second pressure, wherein the source of the highly concentrated micro component has a ratio by weight of micro component to the diluent of at least 1000:1.

8. The system of claim 1 further comprising a source of a diluent configured to provide a flow of the diluent during a second period of time at a second pressure and having one or more of the following:
the diluent comprising a macro component;
the diluent comprising water;
a dispenser configured to allow mixing in the dispenser of the highly concentrated micro component and the flow of the diluent; and a main diluent value, the main diluent valve configured to provide the diluent from the source of diluent to the dispenser, wherein the controller is configured to control the operation of the main diluent valve.

9. The system of claim 8 further comprising a micro dosing device, the micro dosing device configured to receive the highly concentrated micro component from the source of the highly concentrated micro component, and dose the highly concentrated micro component during a third period of time at a third pressure, the third period of time being less than the second period of time, the third period of time overlapping with a portion of the second period of time.

10. The system of claim 9 wherein the micro dosing device is further configured to provide dosing of the highly concentrated micro component during a fourth period of time at a fourth pressure, the fourth period of time being less than the second period of time, the fourth period of time overlapping with a portion of the second period of time, and wherein the third period of time ends before the fourth period of time begins, and the third period of time and fourth period of time in combination are less than the second period of time.

11. The system of claim 10 wherein the third period of time and the fourth period of time are of substantially equal duration.

12. The system of claim 10 wherein the third period of time begins at about the same time as the second period of time begins.

13. The system of claim 10, wherein the fourth period of time ends before the second period of time ends.

14. The system of claim 9 further comprising an actuator, the actuator configured to be actuated by a user, wherein when a user actuates the actuator, the micro dosing device doses the highly concentrated micro component for the third period of time.

15. The system of claim 1 further comprising:
a micro component pump positioned downstream of the source of the highly concentrated micro component and upstream of the micro component valve;
a line between a discharge of the micro component pump and the micro component valve; and
an air vent configured to remove any air trapped in the line.

16. The system of claim 15 wherein the controller is configured to control the operation of the air vent.

17. The system of claim 1 further comprising a regulator positioned downstream of the accumulator and upstream of the micro component valve, the regulator configured to regulate the pressure of the highly concentrated micro component.

18. The system of claim 17 wherein the controller is configured to control the operation of the regulator.

19. A system comprising:
a plurality of highly concentrated micro component sources, each of the plurality of highly concentrated micro component sources having a corresponding micro component;
a plurality of accumulators, each accumulator configured to keep a highly concentrated micro component from a corresponding source of highly concentrated micro component under a pressure corresponding thereto;
a plurality of micro component valves, each micro component valve configured to dose a highly concentrated micro component from a corresponding source of highly concentrated micro component at the pressure corresponding thereto for a period of time corresponding thereto; and
a controller, the controller configured to control the dosing of the highly concentrated micro component by each micro component valve corresponding thereto such that at least one highly concentrated micro component is dosed during the period of time corresponding thereto at the pressure corresponding thereto.

20. The system of claim 19 further comprising a plurality of regulators positioned downstream from the plurality of accumulators and upstream from the plurality of micro component valves, each regulator configured to regulate a pressure of a highly concentrated micro component from a corresponding source of highly concentrated micro component.
